(19) United States
(12) Patent Application Publication
(10) Pub. No.: US 2016/0059208 A1
(43) Pub. Date: Mar. 3, 2016

(54) Reduced Crystalline Silica Diatomaceous Earth Products and Methods of Manufacturing the Same

(71) Applicant: EP MINERALS, LLC, Reno, NV (US)

(72) Inventors: Wilson K. Wanene, Warner Robins, GA (US); Michael J. Nannini, Sparks, NV (US); Peter E. Lenz, Reno, NV (US); Chongjun Jiang, Berwyn, PA (US)

(21) Appl. No.: 14/778,942

(22) PCT Filed: Apr. 11, 2013
(86) PCT No.: PCT/US13/36156

§ 371 Date: Sep. 21, 2015

(51) Int. Cl. B01J 20/14; B01J 20/30

(52) U.S. Cl. CPC B01J 20/14; B01J 20/3021; B01J 20/3078

(57) ABSTRACT

Diatomaceous earth products with reduced amounts of cristobalite and higher Y values are disclosed. The diatomaceous earth products are prepared in a conventional manner to produce a flux-calcine diatomaceous earth. The flux-calcine diatomaceous earth is mixed with potassium hydroxide and the mixture is then heated. The combination of the potassium hydroxide and post-calcining heat treatment results in a diatomaceous earth product with reduced amounts of cristobalite and a whiter, brighter appearance.

### TECHNICAL FIELD

This disclosure relates to diatomaceous earth products with reduced cristobalite content and methods and systems for producing the same.

### BACKGROUND

Diatomaceous earth has been used for many years in a number of applications utilizing its absorptive, filtration and other properties. Diatomaceous earth ore is a naturally occurring ore that is fairly easily crushed into a fine powder. Diatomaceous earth consists primarily of the skeletal remains of diatoms, a type of algae, and includes primarily silica, along with some minor amounts of sodium, aluminum, and iron. The percentages of the various elements may vary depending on the source or collection point of the diatomaceous earth, but generally the silica, in an amorphous form, constitutes over 85% by weight of the diatomaceous earth.

Diatomaceous earth may be used as a filtration aid, a mild abrasive in products including toothpaste, a mechanical insecticide, an absorbent for liquids, a matting agent for coatings, a reinforcing filler in plastics and rubber, an anti-block in plastic films, a porous support for chemical catalysts, cat litter, an activator in blood clotting studies, and a stabilizing component of dynamite. As it is heat-resistant, it can also be used as a thermal insulator.

Diatomaceous earth is an excellent filter aid due to its high porosity and because the porosity can be adjusted by modifying the particle size of the diatomaceous earth product. Diatomaceous earth also can be an excellent filler because, with proper processing, the final diatomaceous earth product can be produced in a bright, white form.

Conventional processes used to produce diatomaceous earth typically begin with a crushing and milling step in which the diatomaceous earth ore is milled in an open circuit to a median particle size of between 10 and 20 micrometers. The milled ore is then sent to a calciner where the ore is heated to temperatures greater than about 1000° C., typically with a fluxing agent. The high temperatures and fluxing agents that are used during calcining produce a product that has high permeability. To make the final product bright, the fluxing agent is typically a sodium fluxing agent.

During the calcining step with the sodium fluxing agent, a significant amount of the amorphous silica of the diatom frustules is converted to crystalline silica, primarily in the form of cristobalite. This conversion occurs during calcination at high temperatures, even with or without the addition of a fluxing agent. Unfortunately, cristobalite may be undesireable, especially when it's in a breathable or airborne form (i.e., particle size smaller than 10 microns). Diatomaceous earth products produced through conventional methods may contain greater than 1 wt % of breathable or airborne cristobalite and generally contain a total of 50-75 wt % of cristobalite. As a result, diatomaceous earth producers are making efforts to reduce the amount of cristobalite in diatomaceous earth products and particularly the amount of breathable or airborne particles of cristobalite or crystalline silica. Unfortunately, these efforts heretofore have not been successful at developing an economical method capable of producing low-cristobalite diatomaceous earth products with the desirable bright, white appearance.

The CIE Standard Observer functions are used to determine how a standard human observer perceives color. The CIE Tristimulus Values (XYZ) are calculated from the CIE Standard Observer functions, and take into account the type of illumination and reflectance of a sample. The XYZ values are calculated based on the luminosity of a perfect reflecting diffuser which has a reflectance of 100 at each wavelength. The Y value for perfect white is equal to 100 by definition. CIE Publication 15.2 (1986) includes information on the XYZ color scale and the CIE Standard Observer functions. For diatomaceous earth products, many applications require a bright, white appearance and, hence, and a high Y value.

It is known that the conversion from amorphous silica to cristobalite occurs at high temperatures, whether flux is added or not, and that the conversion is accelerated when a sodium-based flux is added. Accordingly, efforts to reduce crystalline silica formation have included attempts to calcine without a fluxing agent, to calcine with a non-sodium based fluxing agents (e.g., potassium), to reduce the time the diatomaceous earth is exposed to high temperatures in the calciner (so called “flash calcining”), to eliminate the calcining step altogether, or to add potassium compounds during the flux-calcination. Potassium-based fluxing agents have been successfully used to produce diatomaceous earth filter aids, but the use of potassium-based fluxing agents has not been able to produce medium or high permeability filter aids.

Therefore, there is a need for diatomaceous earth products and methods of making diatomaceous earth products that have a bright white appearance, high permeability and that have low levels of cristobalite.

### SUMMARY

In one aspect, a method for producing a diatomaceous earth product is disclosed. The disclosed method may include milling diatomaceous earth ore to produce milled diatomaceous earth. The milled diatomaceous earth may then be calcined with a sodium flux agent to produce flux-calcined diatomaceous earth or the diatomaceous earth may be straight calcined to produce a straight calcined diatomaceous earth. The term “calcined diatomaceous earth” will be defined herein as covering both flux-calcined and straight calcined materials. The method may then further include mixing the calcined diatomaceous earth with potassium hydroxide to produce a mixture of calcined diatomaceous earth and potassium hydroxide. Finally, the method may include heating the mixture of calcined diatomaceous earth and potassium hydroxide to produce the diatomaceous earth product.

In another aspect, a method of converting diatomaceous earth that has been used as a filter and that contains solid captured during filtration into a low-cristobalite liquid absorbent. This disclosed method may include mixing of the diatomaceous earth and solids with potassium hydroxide to produce a mixture of diatomaceous earth, solids and potassium hydroxide. The method may then further include heating the mixture of diatomaceous earth, solids and potassium hydroxide to produce the low-cristobalite liquid absorbent.

In yet another aspect, a diatomaceous earth product is disclosed that includes diatomaceous earth that may include less than about 55 wt % cristobalite and the diatomaceous earth has a Y value of greater than about 88.

In any one or more of the embodiments described above, the calcined diatomaceous earth may include a first amount of cristobalite and the diatomaceous earth product may include a second amount of cristobalite wherein the second amount is less than the first amount. In a further refinement of this concept, the second amount is less than about half of the first amount. In yet a further refinement of this concept, the second amount may be less than about 25% of the first amount. In still yet another refinement of this concept, the second amount may be less than about 20% of the first amount.

In any one or more of the embodiments described above, the mixture of calcined diatomaceous earth and potassium hydroxide may include up to about 15% potassium hydroxide. In a further refinement of this concept, the mixture may include from about 0.5% to about 15% potassium hydroxide. In yet a further refinement of this concept, the mixture may include from about 2.5% to about 15% potassium hydroxide.

In any one or more of the embodiments described above, the diatomaceous earth product may include from about 10 to about 17% cristobalite.

In any one or more of the embodiments described above, the potassium hydroxide is in a powdered form when it is mixed with the calcined diatomaceous earth. Alternatively, the potassium hydroxide may be added in the form of an aqueous solution or slurry.

In any one or more of the embodiments described above, the heating of the mixture of the calcined diatomaceous earth and the potassium hydroxide is carried out at a temperature ranging from about 649° C. to about 1100° C. In a further refinement of this concept, the temperature may range from about 850° C. to about 1100° C.

In any one or more of the embodiments described above, the diatomaceous earth product has a Y value of at least 88. In a further refinement of this concept, the diatomaceous earth product may have a Y value ranging from about 88 to about 94.

In any one or more of the embodiments described above, the heating of the mixture of calcined diatomaceous earth and potassium hydroxide is carried about for a time period ranging from about 5 minutes to about 40 minutes.

In any one or more of the embodiments described, the diatomaceous earth product includes less than about 20 wt % cristobalite.

### DESCRIPTION

The production of flux-calcined diatomaceous earth filter aids, fillers and other products requires the use of sodium flux compounds that agglomerate and brighten the resulting diatomaceous earth products so that they become suitable for filtration and as functional additives in applications for which natural and straight-calcined grades of diatomaceous earth are not suitable. The addition of the sodium flux, however, has the negative effect on promoting devitrification of the amorphous silica that comprises the diatom frustules, which results in the formation of a crystalline silica phase, known as cristobalite. As noted above, cristobalite, like other forms of crystalline silica such as quartz, may be undesirable. This disclosure is directed towards treating both flux-calcined diatomaceous earth products and straight-calcined diatomaceous earth products that already contain significant amounts of cristobalite to reduce the amount of cristobalite therein. Surprisingly, it has been found that adding potassium hydroxide, either as a solid (powder) or as a solution to existing diatomaceous earth products and applying moderate heat to the mixture has been found to reduce the cristobalite content of the diatomaceous earth products while maintaining or even increasing the brightness of the diatomaceous earth products.

Therefore, in general, the methods disclosed herein include the mixing of potassium hydroxide with a diatomaceous earth product that includes cristobalite. The mixture is then heated and the combination of potassium hydroxide and heat results in a decrease in the crystalline silica or cristobalite content of the diatomaceous earth product. It has been found that adding potassium hydroxide in an amount up to about 15 wt % to a calcined (flux or straight) diatomaceous earth product causes agglomeration during the heat treatment and lowers the cristobalite levels by up to about 87% for flux-calcined diatomaceous earth and up to about 78% for straight calcined diatomaceous earth. It has also been surprisingly found that the addition of potassium hydroxide in combination with the heat treatment can improve the brightness of the final product. As a result, diatomaceous earth flux-calcined filter aids and fillers can be produced that are substantially lower in cristobalite, but that are also brighter in appearance, or have a higher Y value. While previous efforts have been centered on avoiding the formation of cristobalite during the calcination process, no attempts have been made prior to this disclosure at reducing the cristobalite content through a post-calcination treatment.

Various concentrations of potassium hydroxide were added to wet diatomaceous earth products and thoroughly mixed before the thermal treatment at varying temperatures. X-ray diffraction was run before and after the thermal treatment to determine the amount of cristobalite reduction.

Thus, after the milling of diatomaceous earth ore to produce a milled diatomaceous earth and after calcining the milled diatomaceous earth with a sodium flux agent to produce a flux-calcined diatomaceous earth, potassium hydroxide was added at varying levels and thoroughly mixed with the flux-calcined diatomaceous earth to produce a mixture of calcined diatomaceous earth and potassium hydroxide. Thermal treatments at various temperatures were then carried out.

As set forth in Table 1, five (5) wt% potassium hydroxide was added to a diatomaceous earth filter aid product and then heat treated for about 10 minutes at temperatures ranging from 649° C. to 1088° C.

TABLE 1

| Temperature ° F. | (° C.) | % Cristobalite¹ |
|---|---|---|
| As is | | 50 |
| 1990 | 1088 | 11 |
| 1900 | 1038 | 11.9 |
| 1800 | 982 | 16.7 |
| 1700 | 927 | 13.7 |
| 1600 | 871 | 15.6 |
| 1200 | 649 | 30.0 |

¹Determined using x-ray diffraction.

As shown in Table 1, a higher heat treatment temperature provides a greater reduction in the cristobalite amount when the potassium hydroxide is added in an amount of about 5 wt %. In Table 2 below, the amount of potassium hydroxide was varied and the heat treatment was carried out at a temperature of about 1038° C. (1900° F.) for about 40 minutes. The diatomaceous earth product was a functional filler.

TABLE 2

| % KOH added | % Cristobalite | % Reduction | Brightness (Y)² |
|---|---|---|---|
| 0 | 62 | 0 | 90 |
| 0.5 | 60 | 3.3 | 94 |
| 2.5 | 54 | 13 | 94 |
| 5 | 51 | 18 | 94 |
| 10 | 40 | 35 | 92 |
| 15 | 23 | 63 | 88 |

²Measured using Konica Minolta CR-400 color meter.

As shown in Table 2, increased amounts of potassium hydroxide provide a greater reduction in cristobalite. However, the reader will note that when 15% potassium hydroxide is used as opposed to 10% potassium hydroxide, the Y value decreases slightly.

As shown in Table 3 below, the efficacy of potassium hydroxide in a post-calcining heat treatment process carried out at about 1038° C. using about 5 wt % potassium hydroxide results in a substantial reduction in cristobalite. Specifically, the product of Table 3 is a filter product and included 56.7 wt % cristobalite prior to the treatment with potassium hydroxide and heat at 1038° C. When treated with 5 wt % potassium hydroxide and heated at 1038° C. for about 40 minutes, the cristobalite content dropped from 56.7 wt % to 7.2 wt %. or about an 87% reduction in cristobalite.

TABLE 3

| % KOH | % Cristobalite |
|---|---|
| 0 | 56.7 |
| 5 | 7.2 |

Table 4 illustrates the effect of the thermal treatment time at two different temperatures using a 5 wt % potassium hydroxide addition and an initial cristobalite concentration of about 56.7%.

TABLE 4

| Temperature (° F.) | (° C.) | Time (min) | % Cristobalite |
|---|---|---|---|
| As is | | | 56.7 |
| 1900 | 1038 | 40 | 10.6 |
| 1800 | 982 | 40 | 13.7 |
| 1900 | 1038 | 10 | 11.9 |
| 1800 | 982 | 10 | 16.7 |
| 1900 | 1038 | 5 | 35 |
| 1800 | 982 | 5 | 35 |

As shown above in Table 4, increasing the thermal treatment temperature from 982° C. to 1038° C. for time periods greater than 5 minutes results in less cristobalite being present in the final product and the increase in thermal treatment time from 5 minutes to 40 minutes also results in a further reduction of the cristobalite content of the final product for both temperatures.

Table 5 illustrates the effect of a 1900° F. (1038° C.) thermal treatment for 40 minutes on straight calcined diatomaceous earth filter aid at two KOH concentrations, 10% and 5%. Obviously, the 10% KOH concentration provided superior results.

TABLE 5

| % KOH | % Cristobalite | % Reduction |
|---|---|---|
| 0 | 29 | — |
| 5 | 28 | 3.4 |
| 10 | 22 | 24 |

### INDUSTRIAL APPLICABILITY

A process for the preparation of diatomaceous earth products is disclosed wherein the diatomaceous earth is milled and calcined to produce a calcined diatomaceous earth. The calcined diatomaceous earth is mixed with potassium hydroxide in an amount ranging from about 0.5 wt % to about 15 wt % to produce a mixture and the mixture is then heated at a temperature ranging from about 649° C. to about 1088° C. for a time period ranging from about 5 to about 40 minutes. The resulting diatomaceous product has a substantially reduced cristobalite content and a higher Y value or a brighter, whiter appearance.

1. A method of producing a diatomaceous earth product, the method comprising:
milling diatomaceous earth ore to produce milled diatomaceous earth;
calcining the milled diatomaceous earth to produce calcined diatomaceous earth;
mixing the calcined diatomaceous earth with potassium hydroxide to produce a mixture of calcined diatomaceous earth and potassium hydroxide;
heating the mixture of calcined diatomaceous earth and potassium hydroxide to produce the diatomaceous earth product.

2. The method of claim 1 wherein the calcined diatomaceous earth includes a first amount of cristobalite and the diatomaceous earth product has a second amount of cristobalite, the second amount being less than the first amount.

3. The method of claim 1 wherein the calcined diatomaceous earth includes a first amount of cristobalite and the diatomaceous earth product has a second amount of cristobalite, the second amount being less than about half of the first amount.

4. The method of claim 1 wherein the calcined diatomaceous earth includes a first amount of cristobalite and the diatomaceous earth product has a second amount of cristobalite, the second amount being less than about 25% of the first amount.

5. The method of claim 1 wherein the calcined diatomaceous earth includes a first amount of cristobalite and the diatomaceous earth product has a second amount of cristobalite, the second amount being less than about 20% of the first amount.

6. The method of claim 1 wherein the mixture of calcined diatomaceous earth and potassium hydroxide includes up to about 15% potassium hydroxide.

7. The method of claim 1 wherein the mixture of calcined diatomaceous earth and potassium hydroxide includes from about 2.5% to about 15% potassium hydroxide.

8. The method of claim 1 wherein the diatomaceous earth product includes from about 10% to about 17% cristobalite.

9. The method of claim 1 wherein the potassium hydroxide is in a powdered form when it is mixed with the calcined diatomaceous earth.

10. The method of claim 1 wherein the heating of the mixture of the calcined diatomaceous earth and the potassium hydroxide is carried out a temperature ranging from about 649° C. to about 1100° C.

11. The method of claim 1 wherein the heating of the mixture of calcined diatomaceous earth and potassium hydroxide is carried out a temperature ranging from about 850° C. to about 1100° C.

12. The method of claim 1 wherein the diatomaceous earth product has a Y value of at least 88.

13. The method of claim 1 wherein the diatomaceous earth product has a Y value ranging from about 88 to about 94.

14. The method of claim 1 wherein the heating of the mixture of calcined diatomaceous earth and potassium hydroxide is carried out for a time period of ranging from about 5 minutes to about 40 minutes.

15. The method of claim 1 wherein the calcining is carried out using a flux agent to produce a flux-calcined diatomaceous earth.

16. A method of converting diatomaceous earth that has been used as a filter aid and that contains solids captured during filtration into a low-cristobalite liquid absorbent, the method comprising:
mixing the diatomaceous earth and solids with potassium hydroxide to produce a mixture of diatomaceous earth, solids and potassium hydroxide; and
heating the mixture of diatomaceous earth, solids and potassium hydroxide to produce the low-cristobalite liquid absorbent.

17. The method of claim 16 wherein the diatomaceous earth and solids includes a first amount of cristobalite and the low-cristobalite liquid absorbent has a second amount of cristobalite, the second amount being less than the first amount.

18. The method of claim 16 wherein the diatomaceous earth and solids includes a first amount of cristobalite and the low-cristobalite liquid absorbent has a second amount of cristobalite, the second amount being less than half of the first amount.

19. The method of claim 16 wherein the diatomaceous earth and solids includes a first amount of cristobalite and the low-cristobalite liquid absorbent has a second amount of cristobalite, the second amount being less than or about 25% of the first amount.

20. The method of claim 16 wherein the diatomaceous earth is flux-calcined diatomaceous earth.

21. A diatomaceous earth product comprising:
diatomaceous earth that includes less than about 55 wt % cristobalite; and
the diatomaceous earth has an Y value of greater than about 88.

22. The product of claim 21 wherein the diatomaceous earth product includes less than about 20 wt % cristobalite.

23. The product of claim 21 wherein the diatomaceous earth is flux-calcined diatomaceous earth.
